(19) United States
(12) Patent Application Publication
(10) Pub. No.: US 2007/0121887 A1
(43) Pub. Date: May 31, 2007

(54) Telephone system

(75) Inventor: Hideaki Nakai, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/524,263

(22) Filed: Sep. 21, 2006

(30) Foreign Application Priority Data
Sep. 22, 2005 (JP) 2005-276076

(51) Int. Cl. H04M 7/00

(52) U.S. Cl. 379/219

(57) ABSTRACT

According to one embodiment, a telephone system includes at least a single of a first main apparatus and a second main apparatus, the first main apparatus includes a memory which stores a management table in which a plurality telephone terminals housed in the first and the second main apparatuses, respectively, and sate information showing each operation state of the plurality of telephone terminals are associated with each another, and a controller which updates the state information in the management table based on the state information transmitted from the second main apparatus, refers to the management table when an incoming call arrives, and executes incoming call control to the plurality of the telephone terminals based on the reference result, and the second main apparatus includes a transmitter which monitors transmits state information of the telephone terminals of which the operation states have changed to the first main apparatus.

### CROSS-REFERENCE TO RELATED APPLICATIONS

This application is based upon and claims the benefit of priority from Japanese Patent Application No. 2005-276076, filed Sep. 22, 2005, the entire contents of which are incorporated herein by reference.

### BACKGROUND

1. Field

One embodiment of the invention relates to a telephone system, for instance, in which a plurality of main apparatuses are connected with each other via a private network.

2. Description of the Related Art

AS for a networking system, for instance, in an enterprise including a plurality of office branches and sales offices, main apparatuses such as key telephone sets are installed in each branch office or sales office, respectively, to connect among these main apparatuses via a communication network such as a private network. A system of this kind can perform extension communications among different main apparatuses and external line outgoing/incoming calls through the different main apparatuses as well as can perform inter-extension communications and external line outgoing/incoming calls for each main apparatus.

Meanwhile, in this system, an auto call distribution (ACD) service which is implemented in a system of a stand-alone main apparatus has been examined (for example, Jpn. Pat. Appln. KOKAI Publication No. 11-112666). This ACD service is configured in that a single ACD group is composed of a plurality of extension terminals or a plurality of main apparatuses, and prevents a concentration of incoming calls to a specific extension terminal to efficiently treat the incoming calls by equally distributing the incoming calls from external lines. In the ACD group, in general, a single representative telephone number is granted, and a caller can arrive at the extension terminals in the ACD group by dialing the representative telephone number.

In the system, to achieve the ACD service, it is needed to provide resource management databases for an incoming call distribution for each main apparatuses. Therefore, the system compresses a memory capacity by the extent to provide the databases and also has to perform setting registrations of the databases for resource management over again for each main apparatus, respectively, at every time when a system change in telephone number schedule and main apparatus expansion, etc., then, it will take a lot of time and require a great deal of labor to maintain the system.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic configuration view showing a first embodiment of a telephone system regarding the present invention;

FIG. 2 is an exemplary functional block diagram showing a connecting configuration between a main apparatus operating as a master unit and a main apparatus operating as a slave unit in the first embodiment shown in FIG. 2;

FIG. 3 is an exemplary view showing an example of a storage content in a management table shown in FIG. 2;

FIG. 4 is an exemplary view showing another example of the storage content in the management table shown in FIG. 2;

FIG. 5 is an exemplary schematic sequence view showing transmission/reception operations of information between a master main apparatus and a slave main apparatus in performing login state update in the first embodiment of the present invention;

FIG. 6 is an exemplary sequence view showing transmission/reception operations of information between a master main apparatus and a slave main apparatus in performing an ACD, as a second embodiment of the present invention;

FIG. 7 is an exemplary sequence view showing transmission/reception operations of information between a master main apparatus and a slave main apparatus in performing an ACD and waiting a free telephone terminal, as a third embodiment of the present invention; and

FIG. 8 is an exemplary sequence view showing transmission/reception operations of information between a master main apparatus and a slave main apparatus in performing an ACD and in performing an incoming call transfer between a master main apparatus and a main apparatus to be a transfer destination without any free telephone terminal, as a forth embodiment of the present invention.

### DETAILED DESCRIPTION

Various embodiments according to the invention will be described hereinafter with reference to the accompanying drawings, In general, according to one embodiment of the invention, a telephone system, comprising at least a single of a first main apparatus which houses a plurality of telephone terminals and a second main apparatus which is connected to the first main apparatus via a communication network to house a plurality of telephone terminals therein, wherein the first main apparatus comprises: a memory which stores a management table in which a plurality telephone terminals housed in the first and the second main apparatuses, respectively, and sate information showing each operation state of the plurality of telephone terminals are associated with each another; and a controller which updates the state information in the management table based on the state information transmitted from the second main apparatus, refers to the management table when an incoming call arrives, and executes incoming call control to the plurality of the telephone terminals based on the reference result, and the second main apparatus comprises: a transmitter which monitors each operation state of the plurality of the telephone terminals, and when the operation states are changed, transmits state information of the telephone terminals of which the operation states have changed to the first main apparatus.

### First Embodiment

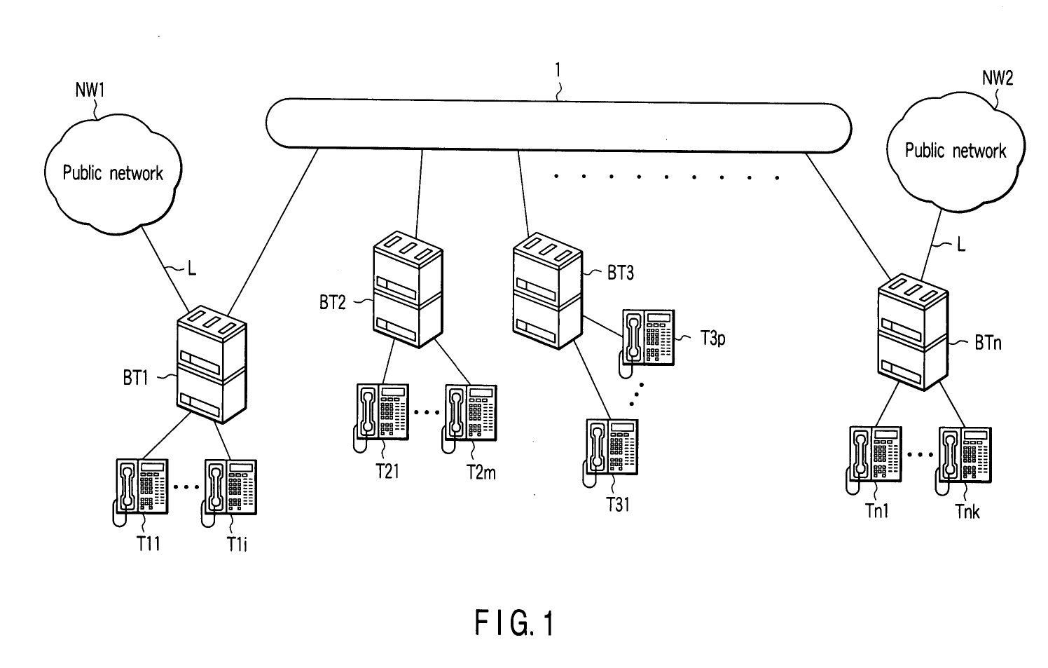

FIG. 1 is the schematic configuration view showing the first embodiment of the telephone system regarding the present invention.

The system includes a private network 1. A plurality of main apparatuses BT1-BTn (n is natural number) are connected to the private network. Telephone terminals T11-T1i (i is natural number), T21-T2m (m is natural number), T31-T3p (p is natural number), and Tn1-Tnk (k is natural number) are connected to the main apparatuses BT1-BTn. The main apparatuses BT1-BTn are connected to public networks NW1 and NW2 via office lines L, respectively.

The main apparatuses BT1-BTn each have normal exchange control functions regarding mutual originating/incoming calls among the telephone terminals T11-T1i, T21-T2m, T31-T3p and Tn1-Tnk, and among public networks NW1, NW2 and the telephone terminals T11-T1i, T21-T2m, T31-T3p and Tn1-Tnk.

The main apparatuses BT1-BTn are divided into extension groups G1 and G2. The main apparatuses BT1, BT2 and BT3 belong to the extension group G1 and the main apparatuses BT4-BTn belong to the extension group G2. In the extension group G1, the main apparatus BT1 operates as a master unit and the main apparatuses BT2 and BT3 each operate as slaves.

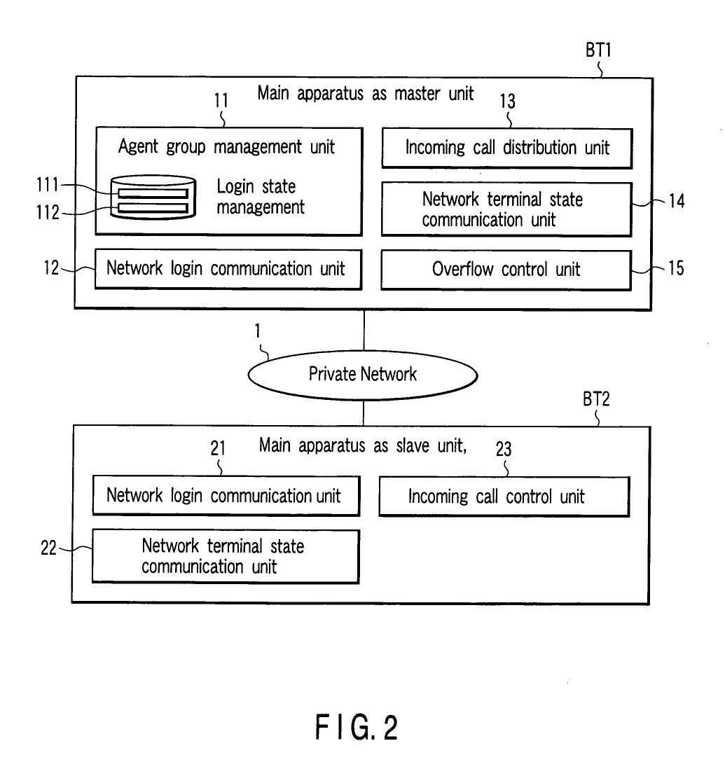

FIG. 2 is a functional block diagram showing a connection configuration between the main apparatus BT1 operating as the master unit and the main apparatus BT2 operating as the slave unit. Wherein, the main apparatus BT2 will be described as a representative of the slave units.

The main apparatus BT1 consists of an agent group management unit 11 (hereinafter referred to as management unit 11), a network login communication unit 12 (hereinafter referred to as communication unit 12), an incoming cal distribution unit 13, a network terminal state communication unit 14 (hereinafter referred to as communication unit 14), and an overflow control unit 15.

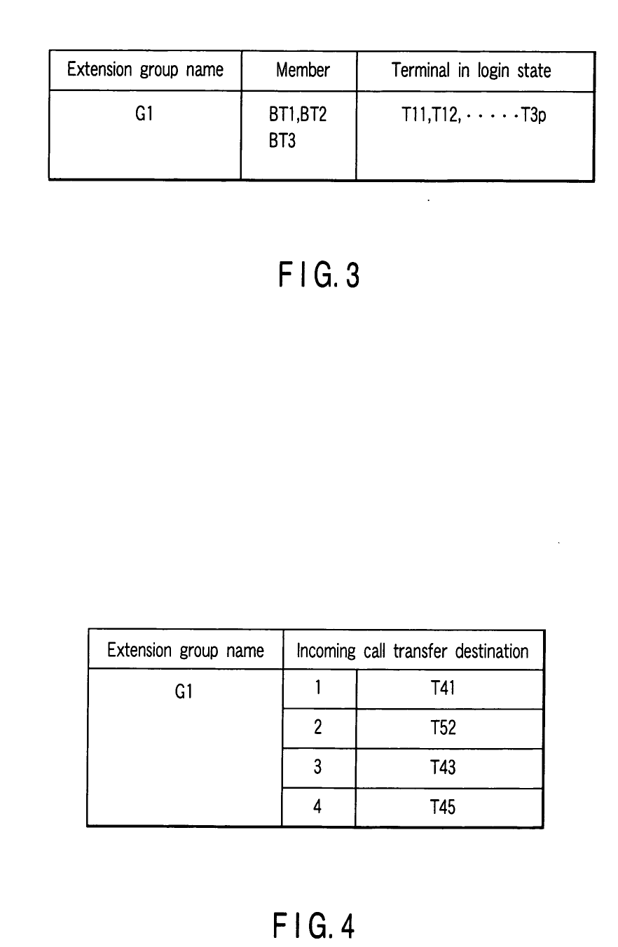

The management unit 11 manages a management table 111 and a transfer destination table 112. The management table 111 stores, as shown in FIG. 3, correspondence relationships among the extension group G1, the main apparatuses BT1, BT2, BT3 belonging thereto, and the telephone terminals T11-T3p belonging to the extension group G1 and being in login states, namely activation states. The transfer destination table 112 stores correspondence relationships among the extension group G1, a plurality of telephone terminals that are the incoming call transfer destinations and their priority order.

The communication unit 12 communicates with the main apparatus BT2 via the private network 1, receives login state update information transmitted from the main apparatus BT2 and updates registration information of the management table 111 of the management unit 11 in response to the update information.

When an incoming call from the public network NW 1 arrives, the incoming call distribution unit 13 inquires reception priorities to the telephone terminals T21-T2m being in login states by referring to the management table 111 and transfers the incoming call to the telephone terminal decided as the incoming call destination.

The communication unit 14 communicates with the main apparatus BT2 via the private network 1 and receives the terminal state update information transmitted from the main apparatus BT2.

The overflow control unit 15 communicates with the main apparatus BT2 via the private network 1, transmits overflow incoming call information to the main apparatus BT4 belonging to a group other than the extension group G1 and receives incoming result information corresponding to the overflow incoming call information.

In contrast, the main apparatus BT2 consists of a network login communication unit 21 (hereinafter referred to as communication unit 21), a network terminal state communication unit 22 (hereinafter referred to as communication unit 22) and an incoming call control unit 23.

The communication unit 21 makes a communication with the main apparatus BT1 via the private network 1, and when the telephone terminals T21-T2m are brought into login states, it transmits login state update information.

The communication unit 22 transmits the terminal state update information to the main apparatus BT1 when the telephone terminals T21-T2m are brought into free states from calling states.

The incoming call control unit 23 performs a communication with the main apparatus BT1 via the private network 1, determines the incoming call priorities of the telephone terminals T21-T2m in response to agent incoming call information transmitted from the main apparatus BT1 to transmit the determination result, and further transmits the incoming call result relating to the overflow incoming call information.

Next, operations of the telephone system configured as given above will be described.

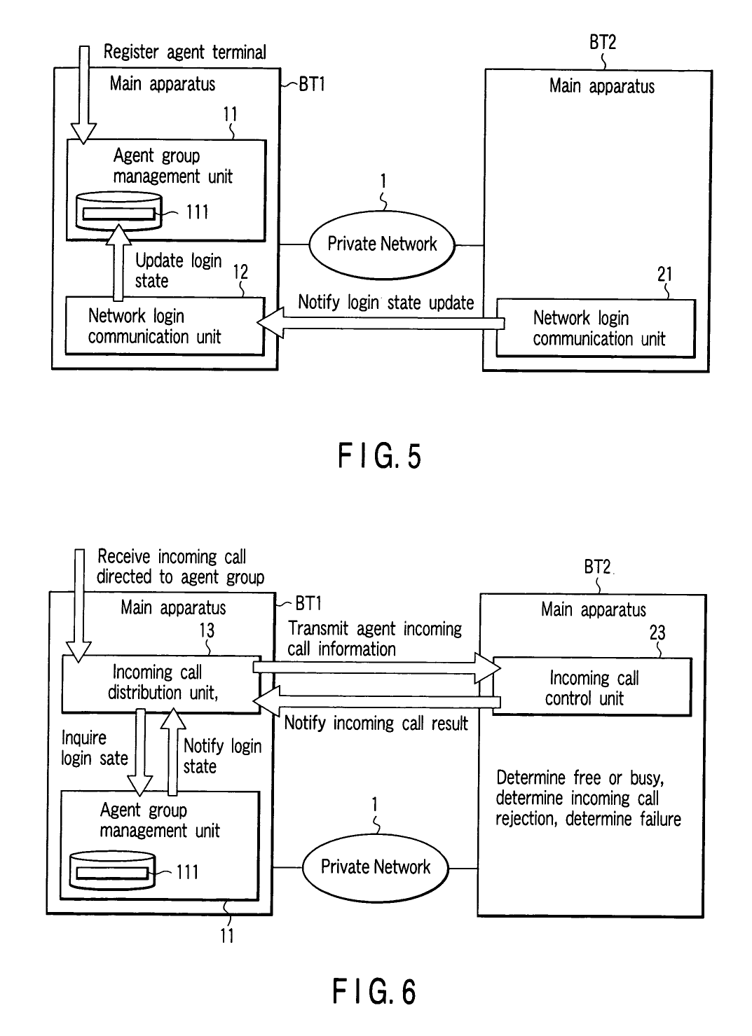

FIG. 5 is a schematic sequence view showing transmission/reception operations of information between the main apparatus BT1 and the main apparatus BT2 in performing login state update.

The main apparatus BT1 registers the extension group G1 and the telephone terminals T21-T2m of the main apparatus BT2 on the private network 1 as agent terminals in the identical group G1 and stores registration information in the management table 111 managed by the management unit 11.

With login operations of the telephone terminals T21-T2m of the main apparatus Bt2 as the slave unit for the main apparatus BT1, the communication unit 21 transmits the login state update notice to the main apparatus BT1, which is the master unit, via the private network 1.

In the main apparatus BT1, the communication unit 12 receives the login state update information from the main apparatus BT2 via the private network 1 to update the registered information in the management table 111 managed by the management unit 11 in accordance with the agent terminal information added to the received information.

As described above, in the first embodiment, the telephone system is constituted in that the extension group G1 is associated with the main apparatuses BT1, BT2 and BT3 in advance, and also the management table 111 showing the correspondence relationships among a plurality of telephone terminals T11-T1i, T21-T2m, T31-T3p and their login states in the extension group G1 are stored only in the main apparatus BT1 operating as the master unit, and each other main apparatus BT2 and BT3 monitors the login states of the telephone terminals T21-T2m and T31-T3p by itself, respectively, to notify the login state information of the logged-in telephone terminals T21-T2m and T31-T3p to the main apparatus BT1.

Accordingly, for instance, the main apparatus BT1 to be used for maintenance becomes possible to integrally manage the login states of the telephone terminals T11-T1i, T21-T2m and T31-T3p housed respectively in the whole of the main apparatuses BT1, BT2 and BT3 in the extension group G1. When it becomes necessary for updating the management table 111 installed in the main apparatus BT1 due to a change in the system, the main apparatus BT1 can perform update control of the management table 111 for each group. Therefore, in the case of sharing a single private network 1 with a lot of main apparatuses BT1-BTn, there is no need to make each main apparatus BT1-BTn has the management tables 111, respectively, thereby the system can reduce loads accompanied by update control of the management table 111 to enable simplify maintenance work thereof.

### Second Embodiment

FIG. 6 is a schematic sequence view showing transmission/reception operations of information between the main apparatus BT1 and the main apparatus BT2 in performing the ACD in the second embodiment of the present invention. Here, it will be described in an assumption that the telephone terminals T11-T1i housed in the main apparatus BT1 are in the not-logged in states. In FIG. 6, the same units as those of FIG. 2 will be put the same symbols and their detailed description will be omitted.

In the main apparatus BT1, when an incoming call directed to the extension group G1 has arrived, the incoming call distribution unit 13 inquires, for instance, a login state of the telephone terminal 21 to finally decide an incoming call destination for the logged in state telephone terminal T21 in accordance with a equal distribution system, and transmits agent incoming call information to the main apparatus BT2 via the private network 1.

In the main apparatus BT2, the incoming call control unit 23 receives the agent incoming call information from the main apparatus BT1 via the private network 1, determines an incoming call destination agent terminal, namely a free/occupied state, presence/absence of incoming call rejection setting and a failure state of the telephone terminal T21, and transmits incoming call result information regarding the agent terminal to the main apparatus BT1 via the private network 1.

In the main apparatus BT1, the incoming call distribution unit 13 analyzes the incoming call result information received from the main apparatus BT2 via the private network 1 inquires the login state of the telephone terminal 22 in accordance with the equal distribution system when the incoming call is not allowed, and finally decides the incoming call destination for the logged in state agent terminal to transmit the agent incoming call information to the main apparatus BT2 via the private network 1 again.

When finally receiving the allowance of the incoming call as the incoming call result information to the agent terminal, namely the telephone terminal T22, the main apparatus BT1 terminates the equal distribution processing by the incoming call distribution unit 13.

As mentioned above, in the second embodiment, when the incoming call directed to the extension group G1 through the public network NW1/NW2 has arrived, the system can perform incoming call distributions to a plurality of telephone terminals T11-T3p for each group by referring to the management table 111.

Conventionally, although the ACD to the agent terminals belonging to the agent group is limited to the main apparatuses belonging to the same agent group, it becomes possible to perform the ACD to any agent belonging to the main apparatuses BT2 and BT3 on the same private network 1 as that of the main apparatus BT1 as the master unit with the agent group set thereto.

### Third Embodiment

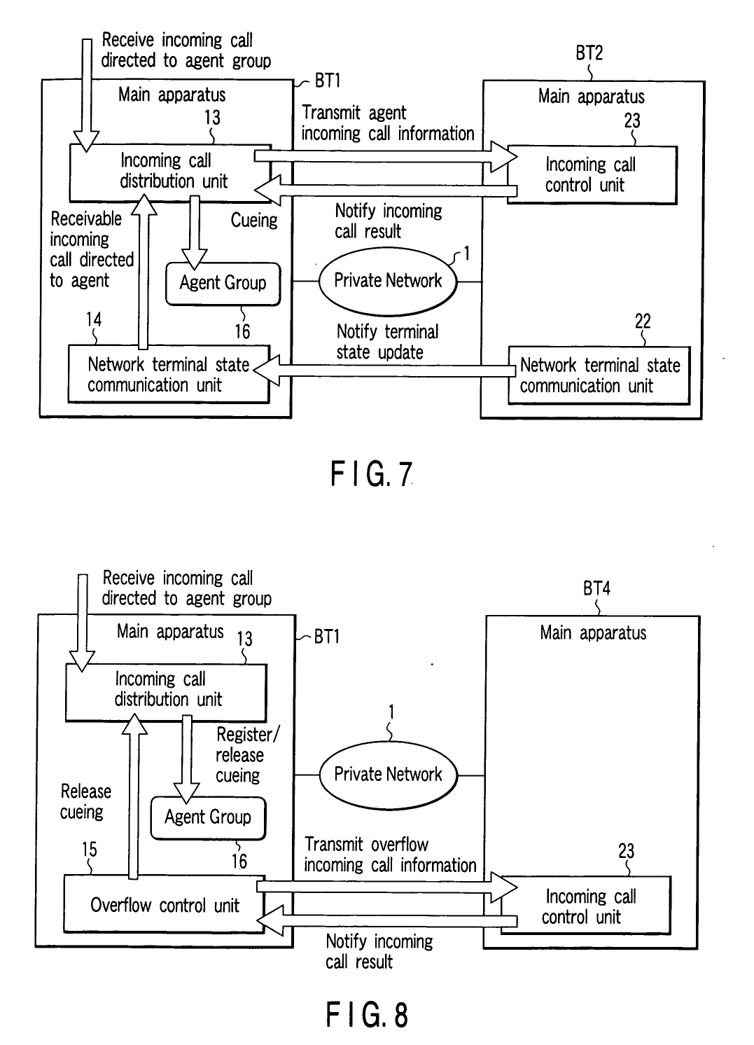

FIG. 7 is a schematic sequence view showing transmitting/receiving operations of information between the main apparatus BT1 and the main apparatus BT2 in performing the ACD and waiting a free telephone terminal, as a third embodiment of the present invention. Here, to explain the third embodiment, it is presumed that the telephone terminals T11-T1i housed in the main apparatus BT1 are in not logged-in stats. In FIG. 7, the same units as those of FIG. 2 will be put the same reference symbols and their detailed description will be omitted.

When whole of the incoming call result information from the main apparatus BT2 finally becomes unable to be received by the agent terminal, namely telephone terminals T21-T2m and when there is no agent terminal possible to receive incoming calls, the main apparatus BT1 makes the incoming calls cue to an agent group. In other words, the main apparatus BT1 holds temporarily the incoming calls in a prescribed memory 16 in the main apparatus BT1.

For instance, when the telephone terminal T22 during calling in the main apparatus BT2 has terminates its calling to transit into an incoming call receivable state, a network terminal state communication unit 22 transmits the state update information of the telephone terminal T22 to the main apparatus BT1 via the private network 1.

In the main apparatus BT1, the communication unit 14 receives the agent terminal state update information from the main apparatus BT2 via the private network 1, and when the communication unit 14 is in an incoming call receivable state, it transmits the agent incoming call information to the main apparatus BT2 that is a slave unit via the private network 1.

After this, the main apparatus BT1 transfers the incoming call held in the memory 16 to a free telephone terminal T22 to receive it.

As mentioned above, in the third embodiment, when the incoming call directed to the extension group G1 has arrived, in the case where all the telephone terminals T11-T3p belonging to the relevant extension group G1 are busy, the main apparatus BT1 does not notify the fact that telephone call cannot be made to any telephone terminals T11-T3p to a call originating source but stores the incoming call in the memory 16 temporarily, then when the telephone terminal 22 in the extension group G1 becomes free, the main apparatus BT1 makes the free telephone terminal T22 receive the incoming call stored in the memory 16.

Accordingly, there is not need for the system to perform transmission operations again from the beginning on an originating side, and the system can surely make the telephone terminal T22 in the extension group G1 receive the incoming call.

### Fourth Embodiment

FIG. 8 is a schematic sequence view showing transmitting/receiving operations of information between the main apparatus BT1 and the main apparatus BT4 in performing the ACD and performing incoming call transfer without a presence of any free telephone terminal. It is supposed that the main apparatus BT4 is constituted in a similar manner to the aforementioned main apparatus BT2.

The main apparatus BT1 stores incoming calls in the memory 16 to wait until any of the telephone terminals T21-T2m of the main terminal BT2 and the telephone terminals T31-T3p of the main terminal BT3 will be free.

However, it is presumed that the telephone terminals T21-T2m of the main terminal BT2 and the telephone terminals T31-T3p of the main terminal BT3 will not be free after the elapse of a fixed time period. Then, in the main apparatus BT1, the overflow control unit 15 refers to the transfer destination table 112 to determine whether or not the incoming call transfer destinations to the extension group G1 have been registered. As shown in FIG. 4, the incoming call transfer destinations to the extension group G1 having been registered, the main apparatus BT1 transmits overflow incoming call information to the main apparatus BT4 via the private network 1 in order to transfer the incoming call to a telephone terminal T41 with the first priority order among the transfer destinations.

In the main apparatus BT4, the incoming call control 23 analyzes overflow incoming call information received from the main apparatus BT1 via the private network 1, determines a free/busy state, presence/absence of incoming call rejection, and failure state of the telephone terminal T41 to be overflow incoming call destination terminal, and transmits incoming call result information relating to the telephone terminal T41 to the main apparatus BT1 via the private network 1.

The main terminal BTI makes the overflow control unit 15 perform processing in response to the incoming call result information of the telephone terminal T41 received from the main terminal BT4 via the private network 1. In the case that the incoming call is receivable, the main apparatus BT1 transfers the incoming calls stored in the memory 16 to a telephone terminal T41 to make it perform incoming call notice.

When the overflow incoming call destination terminal is in calling, in the event of an incoming call rejection, or an occurrence of a failure, so that the main apparatus BT1 transfers the incoming call to a telephone terminal T52 of the main apparatus BT5 with the next priority order, the main apparatus BT1 transmits the overflow incoming call information again to the main apparatus BT5 via the private network 1.

The main apparatus BT1 determines whether or not any free telephone terminal is present within a fixed time period by means of a timer (not shown). The time clocking by the timer is performed in response to the times preset for each extension group.

As mentioned above, in the fourth embodiment, the system can automatically transfer incoming calls stored in the memory 16 to other incoming call receivable telephone terminal T41 to receive them if, for instance, all the telephone terminals T11-T1i, T21-T2m and T31-T3p belonging to the extension group G1 are busy and any telephone terminal will not become free even after the elapse of the fixed time period. Therefore, the incoming calls do not occupy the memory 16 in the extension group G1, and then, the system can enhance an effective use rate of the memory 16. Thereby, the system becomes possible to flexibly control the incoming calls.

In the main apparatus BT1, if a plurality of overflow destinations, namely incoming call transfer destinations are present, having registered the transfer destinations in the transfer destination table 112 in priority order and having selected telephone terminals with higher priority order among these transfer destinations to receive the incoming call, even if the telephone terminal T41 of the transfer destination with higher priority order is in calling, the main apparatus BT1 can select the telephone terminal T52 with the next high priority order to receive the incoming call.

### Other Embodiment

The present invention is not limited to aforementioned embodiments. For instance, having described the example to specify the telephone terminal as the incoming call transfer destination in the fourth embodiment; the present invention is not limited such case, and it may specify a group as the incoming call transfer destination.

In the forth embodiment, having described the example to store the plurality of the telephone terminals as the incoming call transfer destinations together with the priority order, the incoming call transfer destination may be a single telephone terminal or a single group.

Further, each embodiment having been configured so as to assign the main apparatuses operating as the master units for each extension group, the present invention may divide a plurality of main apparatuses operating as slave units into the extension groups to manage each extension group by one set of the main apparatus as the master unit.

Other than this, it is possible to make a variety of modifications to implement the system configuration, the configuration of the main apparatus as the master unit, the configuration of the main apparatus as the slave unit, the types of the communication networks such as private networks, the kinds of the telephone terminals, the control procedures of each control and its control content without departing from the aspect of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone system, comprising at least a single of a first main apparatus which houses a plurality of telephone terminals and a second main apparatus which is connected to the first main apparatus via a communication network to house a plurality of telephone terminals therein, wherein the first main apparatus comprises:
a memory which stores a management table in which a plurality telephone terminals housed in the first and the second main apparatuses, respectively, and sate information showing each operation state of the plurality of telephone terminals are associated with each another; and
a controller which updates the state information in the management table based on the state information transmitted from the second main apparatus, refers to the management table when an incoming call arrives, and executes incoming call control to the plurality of the telephone terminals based on the reference result, and the second main apparatus comprises:
a transmitter which monitors each operation state of the plurality of the telephone terminals, and when the operation states are changed, transmits state information of the telephone terminals of which the operation states have changed to the first main apparatus.

2. The telephone system according to claim 1, wherein the controller refers to the management table when the incoming call arrives, and when the reference result shows that the all the telephone terminals are busy, stores temporarily the incoming call in a recording medium, then when state information showing a telephone terminal becomes free is notified from the second main apparatus, makes the free telephone terminal receive the incoming call stored in the recording medium.

3. The telephone system according to claim 2, wherein
the first main apparatus further comprises a transfer data memory which stores a transfer destination table with at least one of a transfer destination group and a transfer destination telephone terminal to be an incoming call transfer destination associated therewith, when the second main apparatuses are provided in a plural and the plurality of the second main apparatuses are divided into a plurality of extension groups, and
the controller refers the transfer destination table when a prescribed time has elapsed after temporarily storing incoming calls directed to the extension groups in a recording medium, and transfers the incoming calls stored in the recording medium to the corresponding transfer destination groups or the transfer destination telephone terminals based on the reference result.

4. The telephone system according to claim 3, wherein
the transfer data memory stores a plurality of transfer destination groups or a plurality of transfer destination telephone terminals to be incoming call transfer destinations together with priority order, respectively, for each extension group, and the controller refers the transfer destination table when a prescribed time has elapsed after temporarily storing the incoming calls in a recording medium, and selectively transfers the incoming calls stored in the recording medium to the corresponding transfer destination groups or the transfer destination telephone terminals in accordance with their priority order based on the reference result.
